(19) United States
(12) Patent Application Publication
(10) Pub. No.: US 2016/0250769 A1
(43) Pub. Date: Sep. 1, 2016

(54) INSTALLATION AND METHOD FOR DETECTING AND CUTTING FLAT WEB MATERIAL

(71) Applicant: Kuris-Spezialmaschinen GmbH, Deggingen-Reichenbach (DE)

(72) Inventors: Erdal Aygün, Weinstadt (DE); Gerd Wiedmann, Bad Ditzenbach (DE); Martin Bogner, Ostfildern (DE)

(21) Appl. No.: 14/632,401

(22) Filed: Feb. 26, 2015

(51) Int. Cl. B26D 5/00; B26D 7/26; B26D 5/34

(52) U.S. Cl. CPC B26D 5/007; B26D 5/34; B26D 7/2628

(57) ABSTRACT

An installation for detecting and cutting flat web material, in particular animal hides, wherein the installation includes a first workbench having a first worktop for placing flat web material, as well as a second workbench having a second worktop for placing flat web material. A cutting device having a cutting tool for automatically cutting the flat web material is furthermore provided. In order to considerably increase the piece rate which is producible by the installation, it is provided according to the invention that the cutting device includes means for displacing the cutting tool, which are configured to move the cutting tool between the first workbench and the second workbench in such a manner.

### BACKGROUND

Installations and methods for detecting and cutting flat web materials are known in principle. The conventional installations and methods are particularly suited to cutting various types of flat web materials which may be irregular to the extent that they may include different sizes and shapes and/or fault areas. These installations and methods are used for cutting flat web materials in the production of upholstery in motor vehicles, for upholstered furniture, shoes, and other textile items, for example. In the following, the term “flat web material” is used in the context of generally flat materials which is suitable in the production of the abovementioned items.

It is usual practice for the flat web materials to be processed to be placed on a workbench in order to detect their quality parameters, such as shape and fault areas, for example, prior to a cutting operating being carried out. In detail, the flat web material is spread out on the worktop of a workbench, and the contour of said flat web material is detected. With the aid of the contour, a lay-cutting image can be generated by a computer unit, using so-called “nesting”. This lay-cutting image contains individual cut parts which are required in the production of the desired workpieces. The individual cut parts during nesting are arranged within the contours of the flat web material in such a manner that the best possible utilization of the flat web material is ensured. After the lay-cutting image has been calculated, the individual cut parts are either manually or automatically cut out of the flat web material on the worktop of the workbench and cleared from the worktop.

### SUMMARY

Once cut parts and remnants have been cleared from the worktop of the workbench, new flat web material can be placed on the worktop by the operator. In particular in the case of automatic cutting of the flat web materials, this leads to the operator being undeployed during the cutting operation or only being able to supervise the sequence of the cutting operation, respectively. Consequently, the known installations and methods for detecting and cutting flat web material have the disadvantage of the operators not being fully utilized.

The present invention relates to an installation for detecting and cutting flat web material, in particular animal hides. While the use of animal hides is preferable, the present invention is not limited to only workpieces which are made from animal hide, but also comprises the use of the installation or the method, respectively, for further workpieces from various flat materials.

Based on the abovementioned issue, the present invention is based on the object of stating an installation as well as a method for detecting and cutting flat web material, which enables particularly simple and-cost-effective processing of flat web materials.

The present invention accordingly relates to an installation for detecting and cutting flat web material, in particular animal hides, which includes a first workbench having a first worktop for placing flat web material thereon. Furthermore, the installation according to the invention includes a second workbench having a second worktop for placing flat web material thereon. A cutting device having a cutting tool for automatically cutting the flat web material is provided. This cutting device comprises means for displacing the cutting tool, which are configured to move the cutting tool between the first workbench and the second workbench in such a manner that the cutting tool may be selectively used for cutting flat web material on the first worktop or for cutting flat web material on the second worktop.

In other words, two workbenches which are positioned so as to be opposite one another and can be concurrently attended to by one operator are provided in the installation. In order to cut the flat web materials, initially a first flat web material is placed on the first worktop of the first workbench. During cutting of the first flat web material on the first worktop with the aid of the cutting tool, the operator can utilize the time to place a second flat web material on the second worktop of the second workbench. Once the cutting operation on the first worktop has been terminated, the cutting tool can be moved by way of the means for displacement to the second workbench, upon which a cutting operation on the second flat web material is immediately performed. During cutting of the second flat web material, the operator can again utilize the time in order to clear the cut parts of the first flat web material from the first worktop and to place new flat web material on the first worktop.

On account of using two workbenches in an alternating manner it can be achieved that the operator is also fully utilized during the cutting operation. Accordingly, no unnecessary breaks which drive up the production costs are created in the case of the installation or the method, respectively. On account of the means for displacing the cutting tool it is also not necessary to provide one separate cutting tool per workbench. On account thereof, the construction of the installation is considerably simplified and downtime of the cutting tool is significantly reduced.

It is thus provided in a first implementation of the installation for detecting and cutting flat web materials that the means for displacing the cutting tool include a cutting beam which is disposed on a linear guide. Here, the linear guide is in particular conceived for moving the cutting beam back and forth between the first and second workbenches. In particular, since the cutting beam has to be linearly displaceable only in one spatial direction in order to be able to reach both workbenches, said cutting beam is distinguished by particularly low maintenance expenditure. Of course, the alignment of the cutting tool in relation to the worktops has to be performed so as to be accurate to the millimeter in order to be able to ensure cutting with an optimal visual appeal. It is conceivable for this reason that the cutting beam includes stops on each of the two workbenches in order to simplify the erection of the cutting beam in relation to the workbenches.

According to a further embodiment of the installation, said installation furthermore includes a third workbench having a third worktop and at least one sensor device for detecting quality parameters of the flat web material. As has already been indicated, flat web materials such as animal hides not only differ in their size and shape but often also contain faults such as scars, holes, or scratches, as well as textures which are identically differently thick, or other quality parameters which are unique to each hide. It is thus desirable to compare the flat web materials prior to cutting with templates or patterns which represent the desired cut parts, and to move these cut parts across the surface of the flat web materials such that an acceptable arrangement of the cut parts is achieved. This process is referred to as “nesting”, wherein the arrangement of the cut parts created thereby may have a variable shaping and in the following is referred to as the lay-cutting image. On account of the provision of a further third workbench having a further worktop, it is possible for the flat web materials to be detected in terms of their size and quality by personnel already in the receiving region of the goods. This thus has the effect of a temporal separation of detecting and cutting the flat web materials, which may be utilized for optimizing the operational sequence.

The third workbench which is conceived for detecting quality parameters may include an illumination which is sufficient for adequately highlighting fault areas and contours of the flat web material. It may also be provided as facilitation for the operator that the third worktop is inclined in order to facilitate the potential marking of fault areas by the operator.

According to a first implementation, the sensor unit may include a camera and/or a laser scanner for detecting the contours of the flat web material. Of course, all other known means for detecting the contours of the flat web material are also conceivable. Moreover, it is may be preferable for an electronic digitizing pen to be used for marking fault areas in the flat web material. In particular, the markings of the electronic digitizing pen may not be visible on the surface of the flat web material, such that said markings do not have to be taken into account when cutting the individual cut parts. The digitizing pen may also include a function by way of which markings on the flat web material can be immediately corrected. On account of the electronic digitizing pen, detection of fault areas in the flat web material is possible with particularly high accuracy. Alternatively to the electronic digitizing pen which, of course, necessitates manual operation by personnel, detection of fault areas may, of course, also be automatically performed, for example by the camera. On account of the combination of an automatic camera or of a laser scanner, respectively, with an electronic digitizing pen, the highest requirements in respect of accuracy can be met.

According to a further aspect, the third worktop may include a conveyor belt which is configured for guiding the flat web material past the sensor unit. In particular, the conveyor belt here may be configured in a non-slip manner, such that the alignment of the flat web material during the entire operation remains the same. In this manner, a vacuum may be applied on the surface of the conveyor belt, for example, in order secure the flat web material in its position. On account of the configuration of the third worktop with a conveyor belt, the sensor unit may be configured as a linear camera, in particular, past which the flat web material is guided for detecting the contours. An operator may simultaneously and continuously mark fault areas in the flat web material using a digitizing pen. It may be provided that a switch for controlling the indexing of the conveyor belt, which may be used by the operator in order to vary the conveying speed within certain limits. This switch may be configured as a foot pedal and/or as a button on the digitizing pen, for example. Correspondingly, it is possible for the operator to reduce indexing in the case of a large number of fault areas to be marked, in order to simplify the marking operation, for example.

Alternatively to the configuration of the third worktop with a conveyor belt, the camera of the sensor unit may be disposed on the third workbench in such a manner that the camera may be used for detecting the entire third worktop. In other words, it is accordingly possible for the entire contour of the flat web material to be detected at once.

As has already been indicated, on account of the third workbench, detection of the quality parameters of the flat web material may already be performed in the receiving region of the goods. The installation furthermore may accordingly include a computer unit having a data memory, which is connected or connectable to the sensor unit and which is configured for storing the detected quality parameters of the flat web material in the data memory. In particular, the computer unit may be configured for storing the quality parameters of each flat web material in the data memory, using an individual ID-number. The digitized quality parameters can thus be stored and, using software, managed for further processing. In particular, every flat web material can be accordingly provided with an information carrier, such as with a barcode, for example, which carries the individual ID-number of the flat web material. Thereafter, the flat web materials may be stocked in a raw-material stock. On account of the abovementioned configuration of the installation with a computer unit, production planning has the possibility to nest orders on the exact number of required flat web materials. Once the order has been released by production planning, the corresponding flat web material is removed from the raw-material stock by personnel and delivered to the first or second workbench, respectively, of the installation. As has already been mentioned, digitizing using the computer unit is performed so as to be temporally separate from nesting and cutting the flat web materials.

By way of a close collaboration between marketing and production planning, it may thus be determined prior to accepting an order whether the raw material for the future order is available or whether fresh procurement is necessary. Of course, on account thereof, the amount of waste is minimized too, since the computer unit when nesting has at its disposal a large number of different flat web materials. In the case of conventional installations, however, only the laid-out flat web material may be available for nesting.

According to a further aspect of the installation, the first and the second workbenches may in each case include one device for reading the ID-number from an information carrier which is attached to the flat web material. It is thus ensured that the computer unit receives feedback which has been filed on the material for cutting on the first and second workbenches. Operator errors can thus be effectively prevented.

According to a further embodiment, the installation furthermore includes a first projection device which is disposed on the first workbench, and a second projection device which is disposed on the second workbench. The first and second projection devices are configured for projecting contours and fault areas of the flat web material, which are stored in the data memory of the computer unit, onto the first and second worktop, respectively. By projecting the contours and the fault areas of the flat web material onto the first and second worktop, respectively, the alignment of the flat web material on the first and second workbench, respectively, can be optimized. To this end, the operator has only to lay the flat web materials into the projections which are depicted on the worktops. In particular, the contours of the flat web materials here are projected onto the worktops in such a manner that the alignment of the flat web material on the first and second workbench, respectively, exactly corresponds to the original alignment of the flat web material on the third workbench. In particular in the processing of animal hides which are expandable, the flat web material desirably comes to lie on the first and second workbenches, which are configured as cutting benches, in the same state in terms of spatial extent in which it was lying in the receiving region of the goods at the moment of detection of the contour. The projection units may be configured as one beamer or a plurality of beamers which is/are attached on the first and second workbench, respectively, in such a robust manner that unscheduled readjustment of the beamers is required. However, should this be required, this has to be possible by the operator of the installation within a short time.

According to a further aspect, the first and second projection devices may in each case include one controller which is configured for adjusting a luminous intensity by way of which the contours projected by the projection devices are illustrated on the first or second worktop, respectively, to the color hue of the flat web material. For example, it is conceivable for a projection having bright light to be seen in the case of dark leather, and for a projection having less bright light to be seen in the case of light leather. On account thereof, optimal contrast is ensured, facilitating the alignment of the flat web material by the operator on the first and second workbench, respectively.

As has been mentioned, the computer unit, with the aid of the quality parameters stored in the data memory, preferably is configured for generating a lay-cutting image which is illustratable by way of the projection devices on the worktops of the first and second workbenches. However, according to a further embodiment, the projection device is configured for illustrating different cut parts of the lay-cutting image using different colors. This color grading of the various cut parts facilitates clearing by the operator after the cutting operation. For example, it is conceivable that different cut parts belong to different pieces of upholstered furniture. These cut parts may be shown in one color, for example, while cut parts of a further piece of furniture are illuminated in another color. The operator may thus readily perform sorting of the individual cut parts. To this end, the operator has only to sort cut parts having the same color into one and the same container.

The present invention furthermore relates to a method for detecting and cutting flat web material, in particular animal hides. Here, a first flat web material is placed on a first worktop of a first workbench, and cut with the aid of a cutting tool on the first worktop. While cutting the first flat web material on the first worktop, a second flat web material is placed on a second worktop of a second workbench. Once cutting of the first flat web material on the first worktop has been completed, the cutting tool is displaced to the second workbench and used for cutting the second flat web material on the second worktop. Simultaneously, the cut parts of the first flat web material on the first worktop are cleared. Of course, this operation may be repeated arbitrarily.

Like the installation, the method has the advantage of only one cutting tool being required, on account of which the method is performable in a particularly simple and fast manner. In particular, no unnecessary breaks for the operating personnel are created in the case of this method.

As has already been mentioned in the context of the third workbench, the method may furthermore also comprise a step for detecting quality parameters of the flat web materials, prior to placing the flat web materials on the first or second worktops. The quality parameters may be contours, fault areas, or else the color hue of the flat web material.

In order to optimize the generation of the lay-cutting image, the detected quality parameters may be stored in a data memory of a computer unit, using an individual ID-number of the flat web material.

Additionally, the method may in this case comprise a step for marking the flat web materials with the individual ID-number, as well as a step for stocking the marked flat web material in a material stock. It may thus be determined already when receiving an order, whether new flat web materials have to re-procured in order to be able to fulfill the order. Accordingly, it is not necessary for an excessively large stocking area for flat web materials to be set up.

According to a further aspect of the method, the computer unit during compilation of a lay-cutting image selects from the data memory one of the flat web materials which has the optimal quality parameters for an individual cutting order. It should be mentioned in this context that not every flat web material is equally suited to the construction of every item of upholstered furniture or any other item. In particular in the case of animal hides, for example, fault areas which limit the maximum achievable size of cut parts have to be observed. On account of the detection and marking of the individual flat web materials prior to cutting, it is achieved that a far greater number of flat web materials which can be considered by the computer unit is available for cutting.

According to the method, the selected flat web material after nesting is taken from a material stock and placed on one of the workbenches for cutting. To this end, the individual flat web materials are marked with their individual ID-number, using barcodes or chips, for example. The computer can now direct the machine operator as to which of the flat web materials lying in the material stock is to be placed on the respective workbench.

In order to align the flat web materials in an optimal manner when placing them on the worktops, the method furthermore may comprise a step for projecting contours and fault areas onto the first and second worktops, wherein the projections correspond to the detected quality parameters of the flat web material. In other words, this means that the machine operator is not only displayed the ID-number of the flat web material which is to be cut next; rather, also the contour is projected onto the worktops, considerably simplifying the alignment of the flat web material. In particular, to this end the machine operator has only to lay the individual flat web material into the projected contours and to ensure that slipping out of place is prevented.

Additionally to the contours and the fault areas, the method may provide that the lay-cutting image is likewise projected onto the first and second worktops. This has the advantage that the machine operator can check whether the cutting operation is running in a correct manner. For example, should the cutting tool not exactly follow the lay-cutting image, the machine operator can intervene and correct the alignment of the flat web material or of the cutting tool, respectively.

Alternatively or additionally thereto, the projections of the lay-cutting image may be performed using different colors for different cut parts. For example, here different cut parts of different items of upholstered furniture may be coded using different colors. Moreover, during clearing of the individual cut parts, each of the cut parts may be manually or automatically provided with an individual marking. Correspondingly, later identification when using the individual cut parts is considerably simplified. In particular, on account thereof, later processing of the individual cut parts can also be more easily automated.

Finally, it should be pointed out that according to a further embodiment of the method it may be provided that cutting of the flat web materials in the peripheral regions of the flat web materials is performed at a lower cutting speed than in the central regions of the flat web materials. This has the advantage that the flat web materials are exposed to only slight shearing movements, on account of which slipping out of position of the latter is effectively prevented.

### BRIEF DESCRIPTION OF THE DRAWINGS

In the following, the installation as well as the method for detecting and cutting flat web materials is explained in more detail by means of the exemplary embodiments illustrated in the figures, in which:

FIG. 1: shows a lateral view of a first and second workbench according to a first embodiment of the installation;

FIG. 2: shows a plan view onto the first and second workbenches according to the first embodiment illustrated in FIG. 1;

FIG. 3: shows a lateral view of a third workbench according to an embodiment of the installation; and

FIG. 4: shows a plan view onto the third workbench according to the embodiment of FIG. 3.

### DETAILED DESCRIPTION

Following the detailed description of the figures, same parts or parts with the same function are provided with the same reference sign.

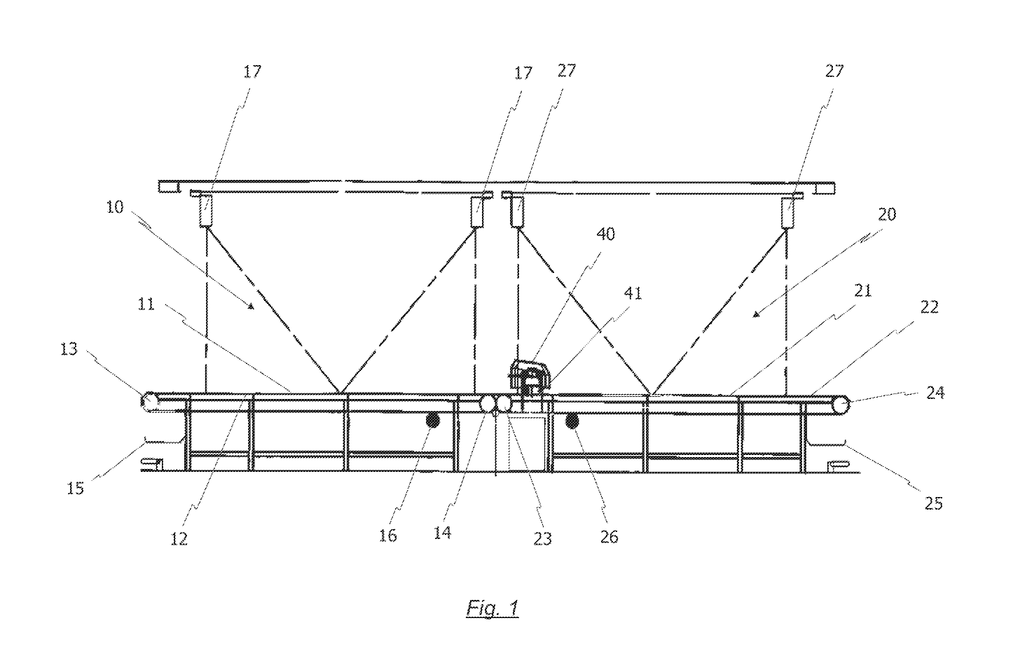

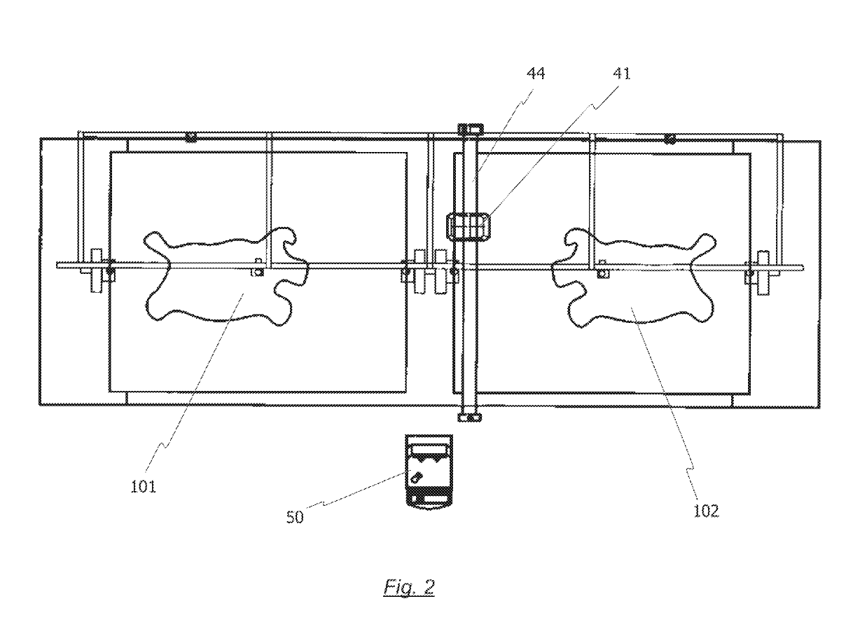

A first embodiment of the installation for detecting and cutting flat web material is illustrated in FIGS. 1 and 2. In particular, the cutting region of the installation is illustrated in FIGS. 1 and 2. Accordingly, the installation includes a first workbench 10 having a first worktop 11 for placing flat web material 101 thereon. Directly beside the first workbench 10, there is a second workbench 20 having a second worktop 21 for placing a second flat web material 102 thereon. The two workbenches are disposed so as to abut one another, wherein it is, of course, also conceivable for these to be spaced apart somewhat. According to the illustrated embodiment, these are disposed along a common longitudinal axis and have identical dimensions.

A cutting device 40 having a cutting tool 41 is attached to the workbenches and configured for automatically cutting the flat web material 101 and 102, respectively. As illustrated, the cutting device includes means for displacing the cutting tool 41. The means for displacing the cutting tool are configured to move the cutting tool 41 between the first workbench and the second workbench 10, 11 in such a manner that the cutting tool 41 may be selectively used for cutting flat web material 101 on the first worktop 11 or for cutting the flat web material 102 on the second worktop 21. To this end, the means for displacing the cutting tool may include a cutting beam 44, for example, which is disposed along a linear guide not illustrated. In the plan view illustrated in FIG. 2, the cutting beam 44 is moved, for example, in a linear manner, to the left and right, back and forth between the first and second workbenches 10, 20. Here, the cutting beam may be moved along the linear guide by an electric motor, for example. Of course, it is also conceivable for other drive means, such as, for example, pneumatic pistons, to be used.

The first and second worktops are configured from felt material which serves as a low-maintenance cutting pad. As illustrated in FIGS. 1 and 2, the felt material here may be part of a conveyor belt 12, 22, which is configured by way of the conveyor rollers 13, 14, and 23, 24, respectively, as an endless belt and thus configures the worktops 11 and 21, respectively. The conveyor belts configured as an endless belt serve for the simplified placing of the flat web material 101 and 102, respectively, on the first and second worktop 11, 12, respectively.

For the intermediate stocking of the flat web materials 101 and 102, respectively, a receiving device 15, 25, which is disposed in the immediate vicinity of the operator, may be provided below the conveyor belt 12, and 22, respectively. The receiving device may receive a plurality of flat web materials to be processed, which the respective operator can arrange in sequence on the workbenches.

As has already been indicated, the installation enables a single operator to simultaneously operate two workbenches. In the case of the exemplary embodiments illustrated here, the operator would thus place a first flat web material 101 on the first worktop 11 of the first workbench 10 and commence the cutting operation of the first flat web material 101 with the aid of a controller 50, such that the first flat web material on the first worktop 11 is cut with the aid of the cutting tool 41. While cutting the first flat web material 101 on the first worktop, the operator may then change over to the second worktop 21 of the second workbench 20 and place a second flat web material 102 on the second worktop 21. After cutting the first flat web material 101 and placing the second flat web material 102 on the second worktop 21, the cutting tool 41 is displaced to the second workbench 20 by the cutting beam 44, upon which the operator activates the cutting operation of the second flat web material 102 with the aid of the controller 50. The operator can now change over to the first workbench again in order to clear the cut parts of the first flat web material 102 and to place new flat web material on the first workbench 10.

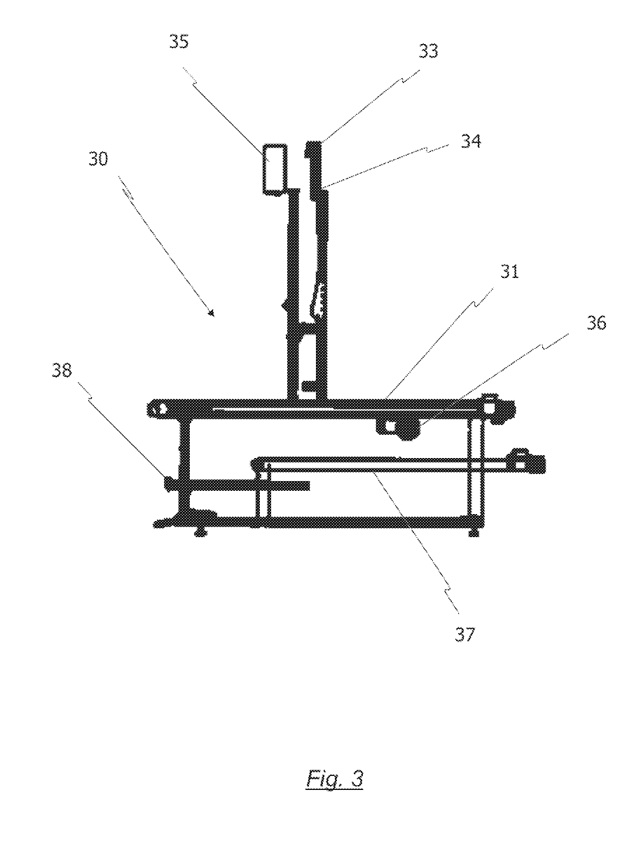

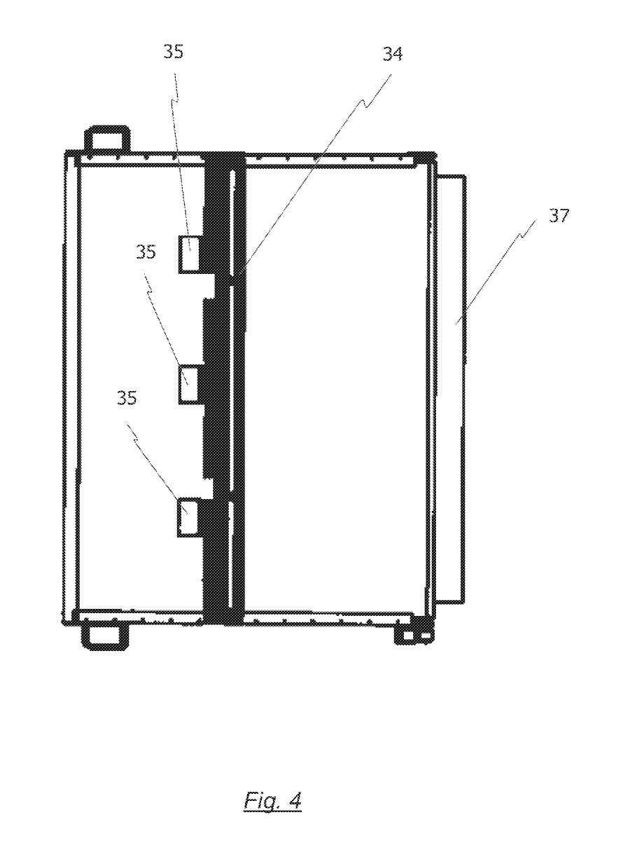

As is illustrated in FIGS. 3 and 4, according to a further embodiment, the installation furthermore may include a third workbench 30 having a third worktop 31 and at least one sensor device 33 for detecting quality parameters of the flat web material 101 and 102, respectively (FIG. 2). The third workbench 30, also referred to as a scanning table, serves for detecting and storing in a data memory the contours and fault areas of the flat web material (for example leather hide). To this end, the flat web material, prior to cutting on the first and second workbench 10 and 20, respectively, (FIGS. 1 and 2) is placed on the third workbench 30 and detected by the sensor device 33. The sensor device 33 which is illustrated here includes a camera 34 which is disposed above the third worktop 31 and serves for detecting the contours of the flat web material. In the exemplary embodiment illustrated, the camera 34 is configured as a linear camera, wherein the third worktop 31 includes a conveyor belt which is configured for guiding the flat web material past the linear camera. A further conveyor belt 37 may be disposed below the third worktop 31 which is configured as a conveyor belt, in order to guide the detected flat web material back to the operator and to deposit it on a depositing plate 38.

In addition to the camera 34, the sensor unit may include an electronic digitizing pen for marking fault areas in the flat web material. The markings of the electronic digitizing pen may not visible on the flat web material. In order to nevertheless enable feedback for the operator, the markings may be intermediately stored in a data memory and, by way of a projection device 35 attached to the third workbench 30, may immediately be projected onto the flat web material during marking. The operator thus may immediately check the fault areas marked by him/her during the detecting operation and correct them if necessary. To this end, it is conceivable for the electronic digitizing pen to include operating elements for erasing existing markings.

In order to regulate the speed of the conveyor belt illustrated in FIGS. 3 and 4, a foot pedal may be provided at the workplace of the operator, by way of which foot pedal the operator may stop the conveyor belt for marking fault areas, for example.

As has already been indicated, the installation furthermore may include a computer unit having a data memory, which is connected or connectable to the sensor unit 33 and which is configured for storing the detected quality parameters, such as, for example, contours and fault areas of the flat web material, in the data memory. The computer unit may be disposed in the controller 50, for example. The quality parameters of the flat web material preferably are stored in the data memory of the computer unit, using an ID-number. Reverting to the first and second workbenches 10, 20, which are illustrated in FIGS. 1 and 2, it should be mentioned that said workbenches are configured for utilizing the quality parameters of the flat web material which are stored in the data memory. To this end, the first and second workbenches 10, 20, may in each case include one device for reading the ID-number from an information carrier attached to the flat web material, such as, for example, a barcode. That is to say that the operator of the first and second workbenches scans the information carrier with the aid of the device for reading the ID-number when placing the flat web materials 101 and 102, respectively, on the worktops 11, 21, on account of which the computer unit attached in the controller receives information pertaining to the quality parameters of the flat web material 101 and 102 to be processed, respectively.

It should be mentioned in this context that the installation may include first projection devices 17 which are disposed on the first workbench 10. In an analogous manner thereto, the second workbench 20 may include second projection devices 27 which are disposed on the second workbench 20. The first and second projection devices 17 and 27, respectively, are configured for projecting the quality parameters (contours around fault areas) of the flat web material 101 and 102, respectively, which are stored in the data memory of the computer unit, onto the first and second worktop, respectively. In particular, the projection devices 17 and 27, respectively, may be beamers, for example, which photocopy the contours and fault areas of the flat web material onto the first and second worktop 11 and 12, respectively. Accordingly, the operator merely needs to align the flat web material along the projected contours and fault areas. Particularly accurate cutting with a visual appeal is thereby produced. As can be seen, in particular from FIG. 1, in each case two projection devices 17 and 27, respectively, are disposed on the first and second workbenches 10, 20, which in each case cover half of the worktops 11 and 21, respectively.

The projection devices 17 and 27, respectively, are not only conceived for projecting the contours and fault areas of the flat web material onto the worktops 11 and 21, respectively, but may also be used for highlighting the completed cut parts after the cutting operation. For example, the cut parts may be highlighted by way of the projection devices 17 and 27, respectively, using different colors, on account of which it is made easier for the operator to clear said cut parts from the worktops 11 and 21, respectively. In this context it is conceivable, for example, that cut parts of a first item of furniture are illuminated using a first color, while parts of a second item of furniture are illuminated using a second color which is different from the first color.

Finally, it should be noted that the first, second, third workbenches, 10, 20, 30, may in each case include cleaning brushes 16, 26, and 36, respectively, which are configured for continuously cleaning the flowing materials of the worktops 11, 21, and 31, respectively, which are configured as a conveyor belt. As is illustrated in FIGS. 1 and 3, the cleaning brushes are in each case disposed below the conveyor belt in order not to influence the detecting and cutting operations of the installation, respectively.

The present invention is not limited to the exemplary embodiments illustrated in the figures, but is also derived from a combination of the features disclosed herein.

1. An installation for detecting and cutting flat web material the installation including:
a first workbench having a first worktop for placing the flat web material;
a second workbench having a second worktop for placing the flat web material; and
a cutting device having a cutting tool for automatically cutting the flat web material, wherein the cutting device includes means for displacing the cutting tool, the means being configured to move the cutting tool between the first workbench and the second workbench in such a manner that the cutting tool may be selectively used for cutting the flat web material on the first worktop or for cutting the flat web material on the second worktop.

2. The installation according to claim 1, wherein the means for displacing the cutting tool includes a cutting beam which is disposed on a linear guide, and
wherein the linear guide is configured such that the cutting beam moves back and forth between the first and second workbenches.

3. The installation according to claim 1, wherein the installation furthermore includes a third workbench having a third worktop and at least one sensor unit for detecting quality parameters of the flat web material,
wherein the first, second, and third worktops of the first, second, and third workbenches, respectively, include workpads made from an identical material,
wherein the workpads of the first, second, and third workbenches are configured as conveyor belts, and
wherein the workbenches include substantially identical support plates for placing the flat web material on the respective workpads.

4. The installation according to claim 3, wherein the at least one sensor unit includes a camera and/or a laser scanner for detecting contours of the flat web material, as well as an electronic digitizing pen for marking fault areas in the flat web material; and/or
wherein the third worktop includes a conveyor belt which is configured for guiding the flat web material past the sensor unit,
wherein the camera of the sensor unit is disposed on the third workbench such that the camera can be used for detecting the entire third worktop; and/or
wherein the installation furthermore includes a computer unit having a data memory, which is coupled to the at least one sensor unit and is configured for storing detected quality parameters of the flat web material in the data memory,
wherein the computer unit preferably is configured for storing the detected quality parameters of the flat web material in the data memory, using an ID-number, and
wherein the first and second workbenches each include a device for reading the ID-number from an information carrier which is attached to the flat web material.

5. The installation according to claim 4, wherein the installation furthermore includes a first projection device which is disposed on the first workbench, and a second projection device which is disposed on the second workbench, and
wherein the first and second projection devices are configured for projecting the contours and the fault areas of the flat web material, which are stored in the data memory of the computer unit, onto the first and second worktops, respectively.

6. The installation according to claim 5, wherein the first and second projection devices each include a controller which is configured for adjusting a luminous intensity by way of which the contours projected by the projection devices are illustrated on the first or second worktop, respectively, the luminous intensity being adapted to the color hue of the flat web material; and/or
wherein the computer unit, with the aid of the detected quality parameters stored in the data memory, is configured for generating a lay-cutting image which is illustratable by way of the first and second projection devices on the first and second worktops of the first and of the second workbenches, and wherein the first and second projection devices are configured for illustrating different cut parts of the lay-cutting image using different colors.

7. A method for detecting and cutting flat web material the method comprising the following steps:
placing a first flat web material on a first worktop of a first workbench;
cutting the first flat web material on the first worktop with the aid of a cutting tool, and placing a second flat web material on a second worktop of a second workbench, while cutting the first flat web material on the first worktop;
displacing the cutting tool to the second workbench;
cutting the second flat web material on the second worktop with the aid of the cutting tool, and
clearing the first cut flat web material from the first worktop.

8. The method according to claim 7, the method further comprising detecting quality parameters of the first and second flat web materials, prior to placing the first and second flat web materials on the first and second worktops, wherein the detected quality parameters are stored in a data memory of a computer unit, using an individual ID-number of the first and second flat web materials;
marking the first and second flat web materials with the individual ID-number; and
stocking the marked flat web material in a material stock.

9. The method according to claim 8, further comprising generating a lay-cutting image by the computer unit according to the data memory the marked flat web material which has optimal quality parameters for an individual cutting order.

10. The method according to claim 9, further comprising taking the marked flat web material from the material stock and placing the marked flat web material on one of the workbenches for the cutting.

11. The method according to claim 9, the method further comprising projecting contours and fault areas onto the first and second worktops, wherein the contours and fault areas correspond to the detected quality parameters of the first and second flat web materials and serve to help align the first and second flat web materials in an optimal manner during the placing.

12. The method according to claim 9, the method further comprising projecting the lay-cutting image onto the first and second worktops.

13. The method according to claim 12, wherein projecting the lay-cutting image is performed using different colors for different cut parts.

14. The method according to claim 11, wherein a luminous intensity with which the contours and fault areas are projected onto the first and second worktops is adapted to the color hue of the flat web material to be placed thereon.

15. The method according to claim 7, wherein each individual cut part is provided with an individual marking during the clearing; and/or
Wherein the cutting of the flat web materials in peripheral regions of the first and second flat web materials is performed at a lower cutting speed than in central regions of the first and second flat web materials.

16. The installation according to claim 2, wherein the installation furthermore includes a third workbench having a third worktop and at least one sensor unit for detecting quality parameters of the flat web material,
wherein the first, second, and third worktops of the first, second, and third workbenches, respectively, include workpads made from an identical material,
wherein the workpads of the first, second, and third workbenches are configured as conveyor belts, and
wherein the workbenches include substantially identical support plates for placing the flat web material on the respective workpads.

17. The method according to claim 10, the method further comprising projecting contours and fault areas onto the first and second worktops, wherein the contours and fault areas correspond to the detected quality parameters of the first and second flat web materials and serve to help align the first and second flat web materials in an optimal manner during the placing.

18. The method according to claim 10, the method further comprising projecting the lay-cutting image onto the first and second worktops.

19. The method according to claim 11, further comprising projecting the lay-cutting image onto the first and second worktops.

20. The method according to claim 12, wherein a luminous intensity with which the contours and fault areas are projected onto the first and second worktops is adapted to the color hue of the flat web material to be placed thereon.
